(19) United States
(12) Patent Application Publication
(10) Pub. No.: US 2005/0262770 A1
(43) Pub. Date: Dec. 1, 2005

(54) Security door

(76) Inventors: Michael Gregory Warriner, Deaville (FR); Martin George Bone, Weybridge (GB)

Correspondence Address: Lawrence G. Fridman, Esq.;Silber & Fridman, Suite 207, 1037 Route 76 East, Clifton, NJ, 07013, US

(21) Appl. No.: 11/136,091

(22) Filed: May 24, 2005

(30) Foreign Application Priority Data
May 25, 2004 (GB) 0411668.7

(51) Int. Cl. E05D 7/00

(52) U.S. Cl. 49/402

(57) ABSTRACT

A security door is mounted for hinged movement on a frame and includes a wrap-around right-angle member mounted for pivotal movement at an edge of the door. In use the wrap-around member projects over a portion of the frame and provides additional locking. In a preferred form the member is controlled by a bar that also inserts and withdraws one or more locking bolts at the same time.

### BACKGROUND OF THE INVENTION

The present invention relates to a security door.

Heavy duty doors, to be used for security purposes, are well known. Such doors may be provided within or at entrances to buildings where there is a risk of unauthorised entry. One example is the security of vacant property, where a normal entrance door is replaced with a temporary steel reinforced security door. A higher degree of resistance to physical attack is available from this type of door.

Prior art security doors commonly have at least two conventional lock points, the keys to which are passed from one user to another when required. Control and tracking of the keys can become a problem or, at least, inconvenience. Time can be wasted in delivering keys between authorised users.

### SUMMARY OF THE INVENTION

In one broad aspect of the present invention there is provided a security door to be mounted for hinged movement on a frame, there being a wrap-around member mounted for pivotal movement at or adjacent an edge of the door to, in use, project over a portion of the frame.

In a preferred form the wrap-around member is situated to project over the frame at a side of the doorway opposed to an opening direction of the door. Preferably, an edge of the door includes an extending portion (security strip) over the frame at the same side as the opening direction of the door.

The wrap-around member may be described simply as a hinged means, that is hinged with an edge of the door at one part and has another edge that swings (“wraps around”) to extend over the frame.

In a preferred form the present invention introduces a “dual locking” feature where one or more bolts are provided to be, in use, extendible into an adjacent doorframe, in addition to the wrap around feature. Preferably the movement of both the bolts and wrap around member is actuated from the same control means.

The present invention provides improved security to prevent break-in over the prior art. Particularly, due to the wrap-around feature on the “inside” of the door and an additional extending edge portion on the “outside” of the door, methods of forcing a door open are foiled.

Security can be further improved by including an extending portion over the frame at the hinge side of the door but on the side opposite the opening direction. This prevents the door being pulled outward from the doorframe.

### BRIEF DESCRIPTION OF THE DRAWINGS

In the accompanying drawings:

FIG. 1 is a plan view of a door and frame,

FIG. 2 is a side elevation view of a door according to the present invention,

FIG. 3 is a plan view of a section of security door according to the present invention,

FIG. 4 is a plan view of a section of a security door,

FIG. 5 is a plan detail view of an opening mechanism in a door according to the present invention,

FIG. 6 is a side elevation detail view of the door from FIG. 5,

FIG. 7 is a sequential view of a door opening mechanism; and

FIG. 8 is a side view of detail indicated in FIG. 6.

### DETAILED DESCRIPTION OF THE INVENTION

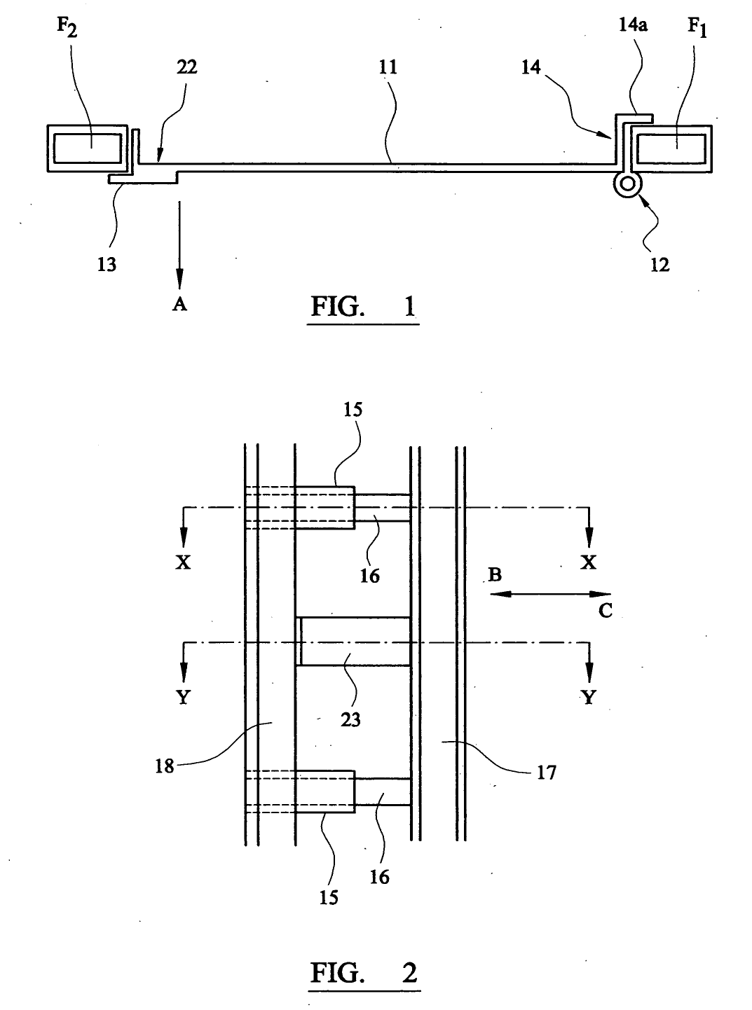

Referring firstly to FIG. 1, a door arrangement such as is applicable to the present invention is shown in plan view. A main door leaf 11 is mounted to a frame F₁ by a hinge 12 in the normal way. The illustrated door also has a security strip 13 that surrounds three edges of the door (the “top” and “bottom” strips cannot be seen in the plan view). Strip 13 protects the externally visible gap between the door leaf 11 and frame F₁/F₂. An internal security angled member 14 extends perpendicularly (then parallel) from an edge of leaf 11 behind hinge 12, allowing the door leaf 11 to swing in only one (outward) direction A. The overhang 14a of member 14 with the frame F₁ prevents the door from being pulled out of the frame even if the hinges 12 were broken or the pin removed. The top and bottom extension of strip 13 prevent the door swinging the other way (inward).

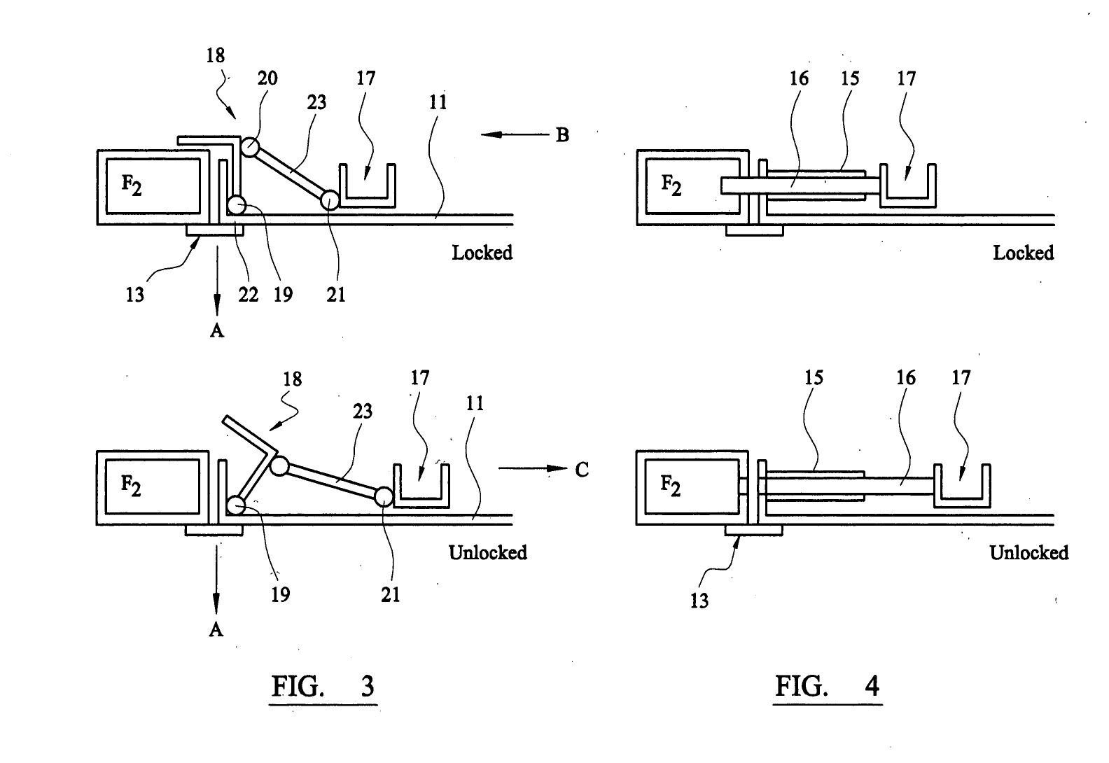

A view from the inside of the door, including a mechanism according to the present invention, is shown by FIG. 2. In this view, welded to the back of the door leaf 11 are guide tubes 15 that carry locking bolts 16 in at least two positions. Movement of bolts 16 in unison is controlled by a box section control bar 17. When bar 17 moves in the direction of arrows B and C the bolts 16 are inserted or withdrawn respectively from corresponding holes formed in the frame F₂. Generally, a lock bolt feature into a frame surrounding a doorway of this type is known to the prior art. Detail of the lock bolts 16 is best seen by FIG. 4 (a locked and unlocked position section X-X).

In addition to the lock bolt feature of FIG. 4 a “wrap-around” member 18 is provided, illustrated by FIG. 3 (section Y-Y taken from FIG. 2). Member 18 is an elongate bar with a right angle, to appear substantially L-shaped in plan view. Three hinged positions 19, 20 and 21 operate a pivoting movement of member 18, controlled by the same bar 17 as operates bolt 16. The first hinge 19 is located to join door leaf 11 and an edge of member 18 at an edge 22 of said leaf. The second hinge 20 is located at the right angle of the L-shaped member 18, pivotally connecting it via a connector 23 to the third hinge point 21 that is at the bar 17 adjacent where it contacts (slidably over the surface) door leaf 11. Note that bar 17 is generally held in position for sliding movement by the guide tubes 15 and the lock bolts 16 that slide within them.

The elongation of member 18 may be of limited length or along most of the edge of leaf 11 adjacent F₂.

The top view of FIG. 3 shows the wrap-around member 18 in a locked position where the leg of the L-shape distal from the first hinge 19 projects over frame F₂. It will be clear that the door leaf 11 cannot be opened in the direction A (shown in FIG. 1) when the member 18 is in a locked position. As bar 17 moves in direction C member 18 swings away to allow the door to be opened. Bar 17 moves locking bolts 16 (FIG. 4) at the same time to withdraw and unlock the door.

In FIG. 3 (and FIG. 1) the door leaf 11 also includes an elongate perpendicularly protruding surface 11a at an edge adjacent frame F₂, this creates a right angle within which hinge 19 is nestled and a stop means against which member 18 can swing no further to protrude over frame F₂. However, this component is not essential.

The mechanisms of FIGS. 3 and 4 provide a dual locking combination for additional security, but operated by the common control bar 17. The wrap-around member 18 is another line of defence, should strip 13 be pried away and bolts 16 cut with some hack-saw edge.

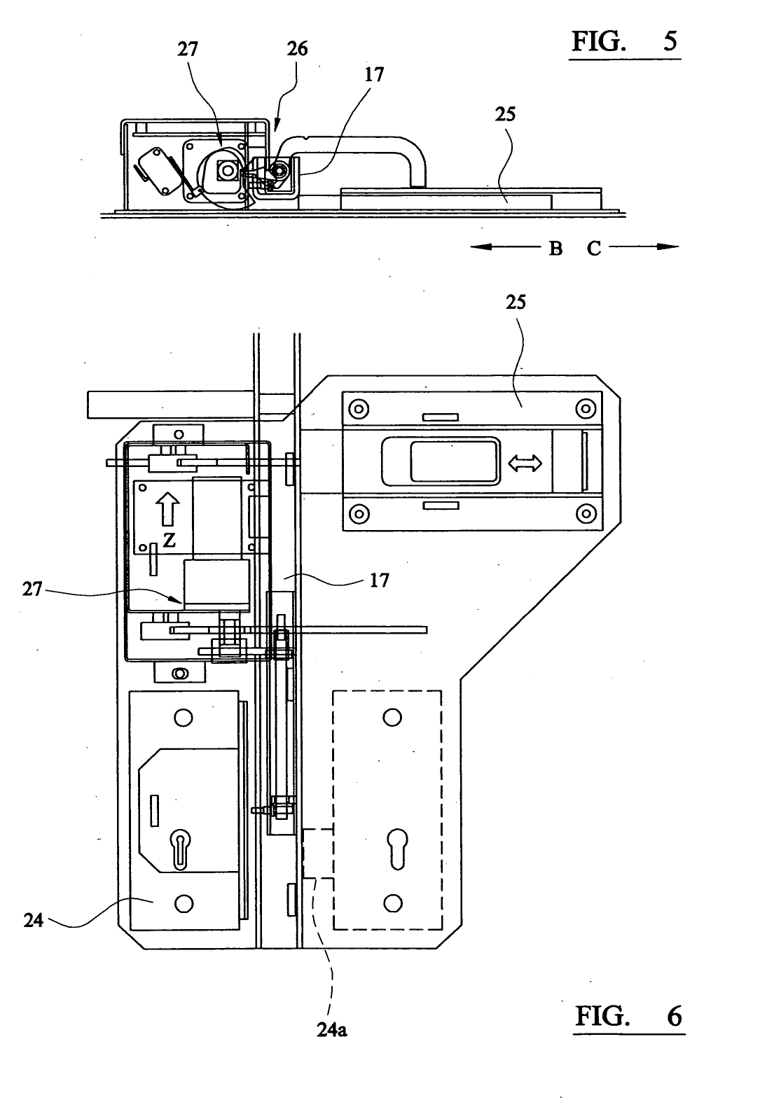

FIGS. 5 and 6 illustrate ways of causing movement to bar 17 that in turn operate the bolts 16 and wrap-around member 18.

A first option is total manual operation of control bar 17 by use of two conventional lever locks (one lock 24 is shown in hard lines in FIG. 5 and another in dotted detail only). The locks are mounted either side of and with tongues 24a facing bar 17. One lock is used to move the control bar to the left (in FIG. 5 this corresponds to locking the door), and the other to the right (unlocking). By operating the appropriate lock with keys in sequence the door, via bar 17, may be locked and unlocked.

FIG. 5 also illustrates a second option (but shown in the same drawing for convenience), featuring an externally accessible free moving locking block 25. In this option, to lock the door the control bar 17 is moved to the locked (arrow B) position by locking block 25. The control bar 17 will then become immoveable from the outside once in the locked position. Control bar 17 is fitted with a latch 26 to ensure that it does not move to the unlocked (arrow C) position.

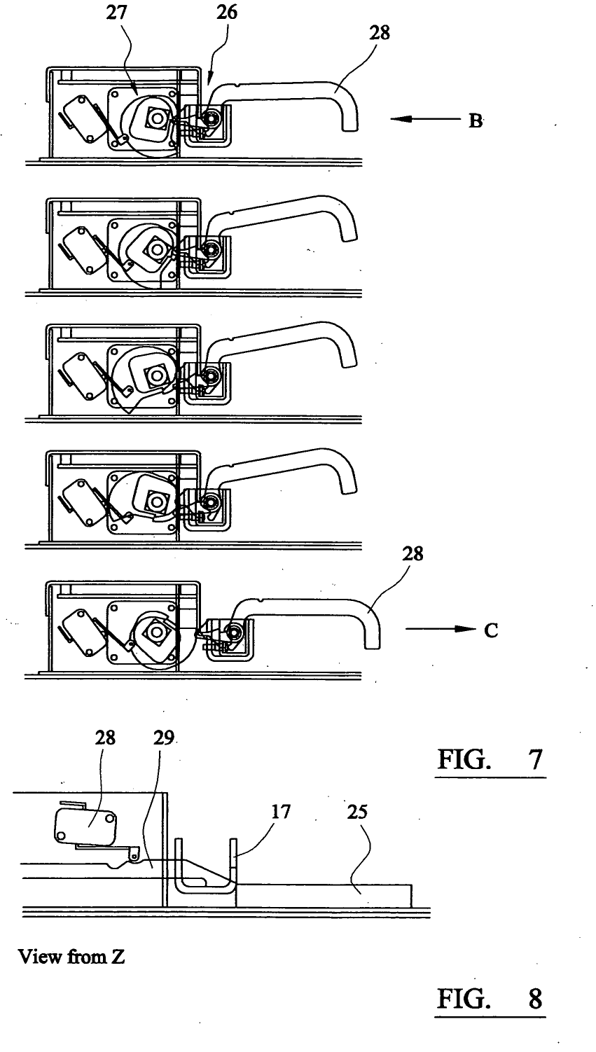

To unlock the door a motor and gearbox combination 27 is used to which a double cam is fitted. As illustrated by FIG. 7, one cam is used to override the latch and the other to push the bar 17 to the unlocked position (the last of the FIG. 7 sequence).

Handle 28 is available to allow personnel within the secure building to manually lock and unlock the door.

FIG. 8 shows a microswitch 28 viewed from arrow Z of FIG. 6. The microswitch simply relays information to an electronic system as to whether bar 17 has been moved into locked (as pictured) or unlocked position by block 25. A narrow sliding member 29 includes contours that receive the microswitch and an end that contacts block 25.

The implementation of the lock/unlock states of the second option can be entirely motorized and controlled electronically, even at a distance (remote control) or by PIN numbers from an external keypad.

Personal Identification Numbers are not always secure and can fall into unauthorised hands; therefore a system can be implemented with the present invention that improves this security. This system includes use of a GSM (Global System Mobile) component that will allow communications with a control centre via cellular telephone networks. This communication will allow PINs to be changed and monitoring of when the door is opened, remote opening and status reports (it is intended for the system to be battery operated—e.g. with a 12 month life).

The control centre has an automated computer system that will generate random PINs and remotely program the door. As an example, at installation it is intended that the control unit will be placed in “receiver” mode. The technician will then contact the control centre to remotely programme the control unit with up to five randomly generated PINs. After receiving this information the control unit will power down to a “standby” mode. The technician will then lock the door and leave the site.

Battery drainage in standby is relatively negligible, however, on a periodic basis the unit will contact the GSM system to report its status and receive any new programming (PINs etc).

If access is required to a site, the user contacts the control centre to obtain a PIN. This PIN may only be valid for a limited period (1 use, 1 day etc). The PIN will then change after this period regardless of whether it is used.

The control centre can track all this information such that an audit will reveal who requested PINs, when they were used etc, for a large number of door installations at different sites.

The keypad interface may also enable a “manual call” to the control centre by entering a special sequence. Furthermore, the keypad/control unit can place an emergency call if it is tampered with.

1. A security door to be mounted for hinged movement on a frame, there being a wrap-around member mounted for pivotal movement at or adjacent an edge of the door to, in use, project over a portion of the frame.

2. The security door of claim 1 wherein the wrap-around member includes a first edge being hingedly connected to the edge of the door.

3. The security door of claim 2 wherein the wrap-around member includes a second edge disposed at a fixed substantially right angle to the first edge, in an L-shape configuration.

4. The security door of claim 1 wherein the wrap-around member is elongate.

5. The security door of claim 1 wherein the wrap-around member is moved by a control bar movable in the plane of the door toward and away from the frame.

6. The security door of claim 5 wherein the control bar moves the wrap-around member pivotally via a connector that is hingedly connected at one end to the wrap-around member and hingedly connected at another end to the control bar.

7. The security door of claim 6 wherein the hinged connection with the wrap-around member is at or adjacent a right angle fixed in the wrap-around member.

8. The security door of claim 5 wherein the control bar also controls, in use, insertion and withdrawal of a locking bolt into and out of a doorframe, simultaneously with operation of the wrap-around member.

9. The security door of claim 8 wherein the locking bolt leads through a guide, the combined arrangement of the locking bolt and guide providing a mount for the control bar.

10. The security door of claim 5 wherein the control bar is operated externally of the door.

11. The security door of claim 5 wherein the control bar is moved by at least one key operated means.

12. The security door of claim 11 wherein two key operated locks are situated either side of the control bar such that tongues extending from the respective locks move the control bar between a first and second position.

13. The security door of claim 5 wherein the control bar is activated electronically.

14. The security door of claim 13 wherein the control bar is activated by a keypad.

15. The security door of claim 1 wherein the door includes a stop element at an edge of the door mounted for hinged movement on the frame to limit the door swinging to one direction.

16. The security door of claim 15 wherein the stop element includes an extension to protrude over the doorframe.
